(19) United States
(12) Patent Application Publication
(10) Pub. No.: US 2019/0177991 A1
(43) Pub. Date: Jun. 13, 2019

(54) TILE REMOVAL APPARATUS

(71) Applicants: Stephen A. Zimmerli, Fairfax Station, VA (US); David H. Stroup, Fairfax Station, VA (US)

(72) Inventors: Stephen A. Zimmerli, Fairfax Station, VA (US); David H. Stroup, Fairfax Station, VA (US)

(21) Appl. No.: 15/682,482

(22) Filed: Aug. 21, 2017

Related U.S. Application Data
(60) Provisional application No. 62/377,218, filed on Aug. 19, 2016.

(51) Int. Cl. E04G 23/00; B26B 3/00; E04F 15/02

(52) U.S. Cl. CPC E04G 23/006; E04G 23/06; E04F 15/02133; B26B 3/00

(57) ABSTRACT

The present invention provides a flooring removal apparatus that includes a base portion formed of a metal material. The base portion includes a top angled portion configured to be angled at a top surface thereof to a predetermined angle, and a support portion adjacent to the top angled portion. The support portion is positioned on a hard surface and includes a body, and a first connection means within the body. The apparatus also has a handle portion for gripping the flooring removal apparatus, the body of the support portion is configured to receive the handle portion attachable to the base portion.

### I. CROSS-REFERENCE

The present invention is a non-provisional application claiming priority to a Provisional Application Ser. No. 62/377,218 filed on Aug. 19, 2016, in its entirety.

### II. TECHNICAL FIELD

The technical field relates generally to a flooring (e.g., tile) removal apparatus.

### III. SUMMARY OF THE EMBODIMENTS

Embodiments of the present invention provide a flooring removal apparatus. The apparatus includes a base portion formed of a metal material. The base portion includes a top angled portion configured to be angled at a top surface thereof to a predetermined angle, and a support portion adjacent to the top angled portion. The support portion is positioned on a hard surface and includes a body, and a first connection means within the body. The apparatus also has a handle portion for gripping the flooring removal apparatus, the body of the support portion is configured to receive the handle portion attachable to the base portion.

### IV. DESCRIPTION OF THE DRAWINGS

FIG. 1 includes a flooring removal apparatus that can be implemented within one or more embodiments of the present invention.

The patentable scope of the invention may include other examples that occur to those skilled in the art.

### V. DETAILED DESCRIPTION OF THE INVENTION

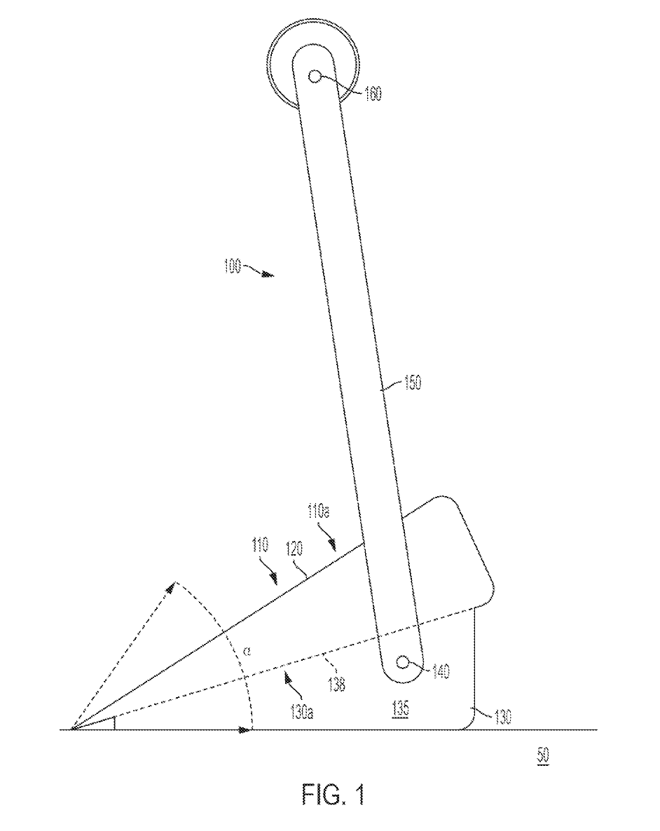

The present invention provides a tile/flooring removal apparatus for removing tile and other types of flooring as shown in the attached FIG. 1. The present invention is not limited to removal of flooring and may be used for other purposes.

According to one embodiment, the flooring removal apparatus 100 includes a base portion 110 formed of a metal material for example, steel or aluminum. The base portion 110 is not limited to being formed of a particular material and may vary as necessary.

The base portion 110 includes a top angled portion 120 which angles at a top surface 110a thereof to a predetermined angle α, for example, 20 to 75 degree angle. The present invention is not limited to any particular angle α and therefore may vary as desired.

The base portion 110 further includes a support portion 130 adjacent to the top angled portion 120. The support portion 130 is positioned on a hard surface 50 such as the floor and includes a first connection means 140 within the body 135 thereof for receiving a handle portion 150 attachable to the base portion 110.

The support portion 130 may include a top surface 130a having an angled edge 138 for receiving the top angled portion 120.

Both the top angled portion 120 and the support portion 130 can be formed of the same metal material or other suitable material. Alternatively, the top angled portion 120 and the support portion 130 can be formed of different metal materials or other suitable materials.

The support portion 130 can be solid component or it may be hollowed out. Alternatively, the support portion 130 can be a boxed support type structure. The present invention is not limited to the support portion 130 being any particular size or type.

According to one or more embodiments, the support portion 130 and the top angled portion 120 are integrally formed together as a single component.

The adjustable handle portion 150 is connected to the support portion 130 by the first connection means 140. The first connection means 140 may be a nylon lock bolt passing through the support portion 130. The first connection means 140 can be any other type of connection component suitable for the purpose herein. The first connection means 140 enables tension adjustment to allow adjustment of the handle portion 150 in a forward or backward direction. The handle portion 150 is also adjustable in a vertical direction based on the desired height of the user.

A second connection means 160 is attached to the opposite end of the handle portion 150 to allow adjustment at that end thereof. Therefore, the handle portion 150 can be adjusted at the user end. The present invention is also not limited to a particular type of material for the handle portion 150. Further, a separate handle portion can be provided and attached to the second connection means 160 for facilitating adjustment in the vertical direction or forward and backward direction at the user end.

The present invention is not limited to the design as set forth herein. Various embodiments of this design can be implemented.

What is claimed is:

1. A flooring removal apparatus comprising:
a base portion formed of a metal material, the base portion comprises:
a top angled portion configured to be angled at a top surface thereof to a predetermined angle;
a support portion adjacent to the top angled portion, wherein the support portion is positioned on a hard surface and comprises a body, and a first connection means within the body; and
a handle portion for gripping the flooring removal apparatus, wherein the body of the support portion is configured to receive the handle portion attachable to the base portion.

2. The flooring removal apparatus of claim 1, wherein the metal material comprises one of steel or aluminum.

3. The flooring removal apparatus of claim 2, wherein the predetermined angle is approximately 20 degrees to approximately 75 degree.

4. The flooring removal apparatus of claim 1, wherein the support portion further comprises a top surface having an angled edge for receiving the top angled portion.

5. The flooring removal apparatus of claim 2, wherein the top angled portion and the support portion are formed of the same metal material.

6. The flooring removal apparatus of claim 2, wherein the top angled portion and the support portion are formed of different metal materials.

7. The flooring removal apparatus of claim 1, wherein the support portion is formed as a solid component.

8. The flooring removal apparatus of claim 1, wherein the support portion is formed as a hollow component.

9. The flooring removal apparatus of claim 1, wherein the support portion is formed of a boxed support type structure.

10. The flooring removal apparatus of claim 1, wherein the support portion and the top angled portion are integrally formed together as a single component.

11. The flooring removal apparatus of claim 1, wherein the handle portion connected to the support portion by the first connection means.

12. The flooring removal apparatus of claim 11, wherein the first connection means comprises:
a nylon lock bolt passing through the support portion, wherein the first connection means is configured to provide tension adjustment to allow adjustment of the handle portion in a forward or backward direction.

13. The flooring removal apparatus of claim 11, wherein the handle portion is adjustable in a vertical direction based on a desired height of a user.

14. The flooring removal apparatus of claim 12, further comprising:
a second connection means is attached to the opposite end of the handle portion to allow adjustment at that end thereof.
